(19) United States
(12) Patent Application Publication
(10) Pub. No.: US 2016/0307174 A1
(43) Pub. Date: Oct. 20, 2016

(54) DIGITAL PLATFORM AND METHODS OF USE

(71) Applicant: GOMOTO, INC., Arlington, VA (US)

(72) Inventors: Todd Marcelle, Arlington, VA (US); Robert Florig, Philadelphia, PA (US); Marc Rubino, Haddonfield, NJ (US); Benjamin Catanese, Media, PA (US)

(21) Appl. No.: 15/133,800

(22) Filed: Apr. 20, 2016

Related U.S. Application Data
(60) Provisional application No. 62/149,906, filed on Apr. 20, 2015.

(51) Int. Cl. G06Q 20/18; G06Q 30/06; G06Q 10/08; G06Q 40/02

(52) U.S. Cl. CPC G06Q 20/18; G06Q 40/025; G06Q 30/0621; G06Q 10/087

(57) ABSTRACT

A digital platform connected and accessed by one or more computing systems via a network connection. Said digital platform being loaded into the memory of the one or more computing systems and comprising a content management system, a customer database and a communications platform, allowing the display and manipulation of content by a user operating the digital platform remotely. Said digital platform being operated remotely being capable of recording and tracking the user's interaction with the computing system, storing the recorded information to the customer database and providing the information to participating parties having access to retrieve the information from the customer database, generating both sales leads and product sales.

### CROSS REFERENCE TO RELATED APPLICATIONS

This application claims the priority and benefit of U.S. Patent Application No. 62/149,906 filed Apr. 20, 2015, entitled “DIGITAL PLATFORM AND METHODS OF USE”, the content of which is incorporated herein by reference.

### FIELD OF THE TECHNOLOGY

The following relates generally to a digital platform and methods of using the digital platform, more specifically to a network based platform integrating one or more systems accessed in one or more locations and methods for applying the platform to the purchase, sale or maintenance of automobiles.

### BACKGROUND

In the modern era, computers and digital networks such as the internet, have positioned their way into the lives of nearly all Americans and people around the world, in one form or another. Individuals use these networks for researching, viewing and potentially purchasing products remotely with increased regularity. Internet domains such as Amazon, eBay, Netflix and iTunes, have become staples for many individuals to purchase both physical products and digital ones. Individual users may often decide to purchase or research a product using online networks as opposed to physically entering a storefront containing the product for many reasons. For example, users may desire to research the item at their own pace, cross-shop multiple brands that may not be available at a single location, avoid pushy salesmen or even to identify the best price before committing to a final purchase.

In the realm of automobile purchasing, a customer using an internet domain or a digital network unaffiliated with a dealership or network of dealerships can result in lost sales leads or even the opportunity to engage the customer at all. There is a growing trend by potential automotive buyers to begin their research online in order to identify their preferences for various vehicle brands, models, features and options. However, with many options available for performing research, dealerships may be unable to present information, influence the automotive buyer before they have made up their mind or even entice the buyer to enter their dealership. This lost opportunity is further compounded with a lost opportunity for obtaining general information about purchasing trends in the automotive market for particular demographics. Failing to entice customers to enter the specific dealership, or use the dealer's specific platforms results in less sales opportunities and a decreased ability to collect valuable statistics about the automotive market. An automotive dealership is unable to approach customers, make a potential sale, upsell the customer on additional features or services and collect the important demographic data, if potential clients or client information is inaccessible to the dealership by virtue of more users using online networks unaffiliated with the dealership.

Thus, a need exists for a digital platform accessible to both the potential purchaser and the potential dealership, which bridges the gap between the buyer's research experience digitally and the dealership its, providing an avenue for the potential client to be full informed about their purchasing decisions while still allowing dealers to obtain sales leads and market trend information.

### SUMMARY OF THE TECHNOLOGY

A first embodiment of this disclosure relates generally to a method for selling an automobile comprising the steps connecting, by a computer processor, a computing system to a digital platform via a network connection; identifying, by the computer processor, a user operating the computing system; manipulating, by the computer processor, as a function of input data by the user, an automobile-related feature displayed by the computing system; recording, by the computer processor, the manipulation of the automobile-related feature to an entry in a database describing the manipulating step and the user of the computing system; storing, by the computer processor, the entry of the database on the digital platform; and transmitting, by the computer processor, the entry in the database to a participating dealership having access to the database of the digital platform.

A second embodiment of this disclosure relates generally to a computer program product, comprising a computer readable hardware storage system having computer readable program code stored therein, said program code containing instructions executable by a computer processor to implement a method for selling an automobile comprising the steps of connecting, by a computer processor of a computing system, the computing system to a digital platform via a network connection; identifying, by the computer processor, a user operating the computing system; manipulating, by the computer processor, as a function of input data by the user, an automobile-related feature displayed on the computing system; recording, by the computer processor, the manipulation of automobile-related feature to an entry in a database describing the manipulating step and the user of the computing system; storing, by the computer processor, the entry of the database on the digital platform; and transmitting, by the computer processor, the entry in the database to a participating dealership having access to the database of the digital platform.

A third embodiment of this disclosure relates generally to computer system comprising a computer processor; a memory system coupled to the computer processor; a computer readable storage system coupled to the processor, wherein the computer readable storage system contains program code executable by the computer processor via the memory system to implement a method for selling an automobile comprising the steps of: connecting, by the computer processor, the computer system to a digital platform via a network connection; identifying, by the computer processor, a user operating the computing system; manipulating, by the computer processor, as a function of input data by the user, an automobile-related feature displayed on the computing system; recording, by the computer processor, the manipulation of automobile-related feature to an entry in a database describing the manipulating step and the user of the computing system; storing, by the computer processor, the entry of the database on the digital platform; and transmitting, by the computer processor, the entry in the database to a participating dealership having access to the database of the digital platform.

### BRIEF DESCRIPTION OF THE DRAWINGS

Some of the embodiments will be described in detail, with reference to the following figures, wherein like designations denote like members, wherein:

FIG. 1 depicts a schematic of an embodiment of a digital platform communicating and providing content to a computing system;

FIG. 2 depicts a schematic of an embodiment of a digital platform communicating and providing content to a plurality of computing systems;

FIG. 3 depicts a schematic of an embodiment of a digital platform communicating and providing location and system specific content to a user;

FIG. 4 depicts a schematic of an embodiment of a digital platform, loading, registering, recording, displaying and updating user directed content;

FIG. 5 depicts a schematic of an embodiment of a digital platform updating and forwarding user created requests to network participants;

FIG. 6a depicts a front view of an embodiment of a computing system;

FIG. 6b depicts a side view of the embodiment of the computing system of FIG. 6a;

FIG. 6c depicts a rear view of the embodiment of the computing system of FIG. 6a; and

FIG. 7 depicts an embodiment of a computing system capable of implementing the embodiments of the present disclosure.

### DETAILED DESCRIPTION OF THE DISCLOSURE

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

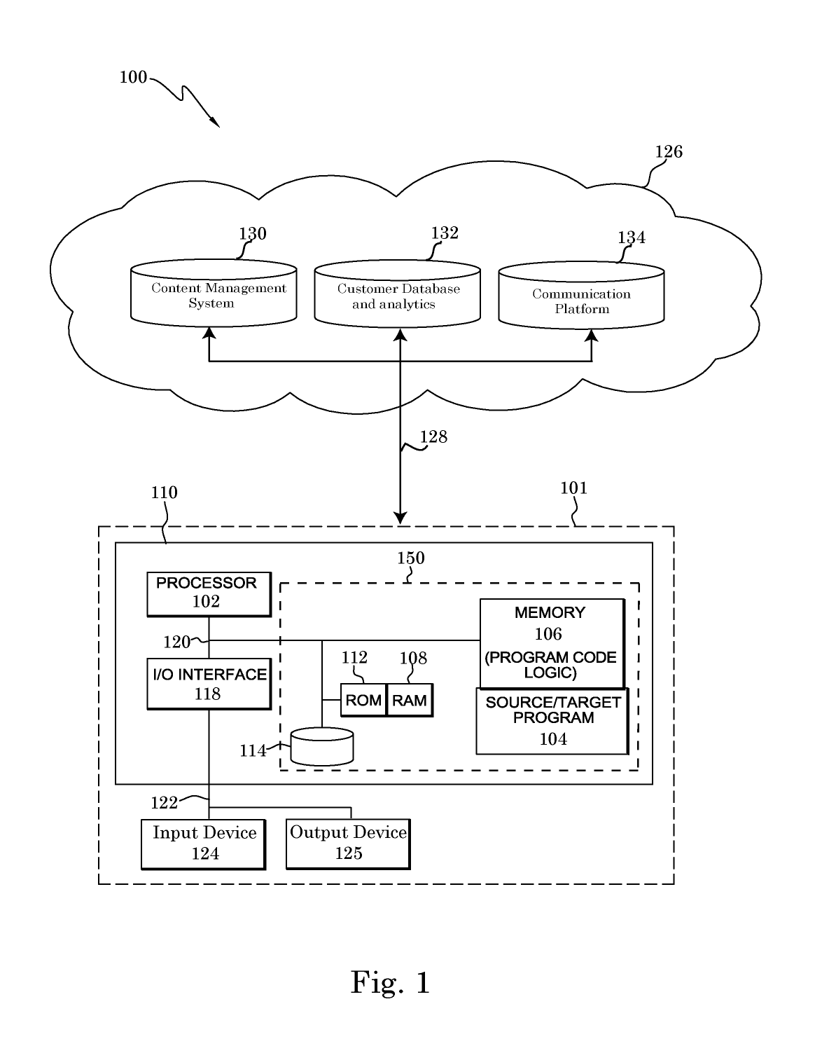

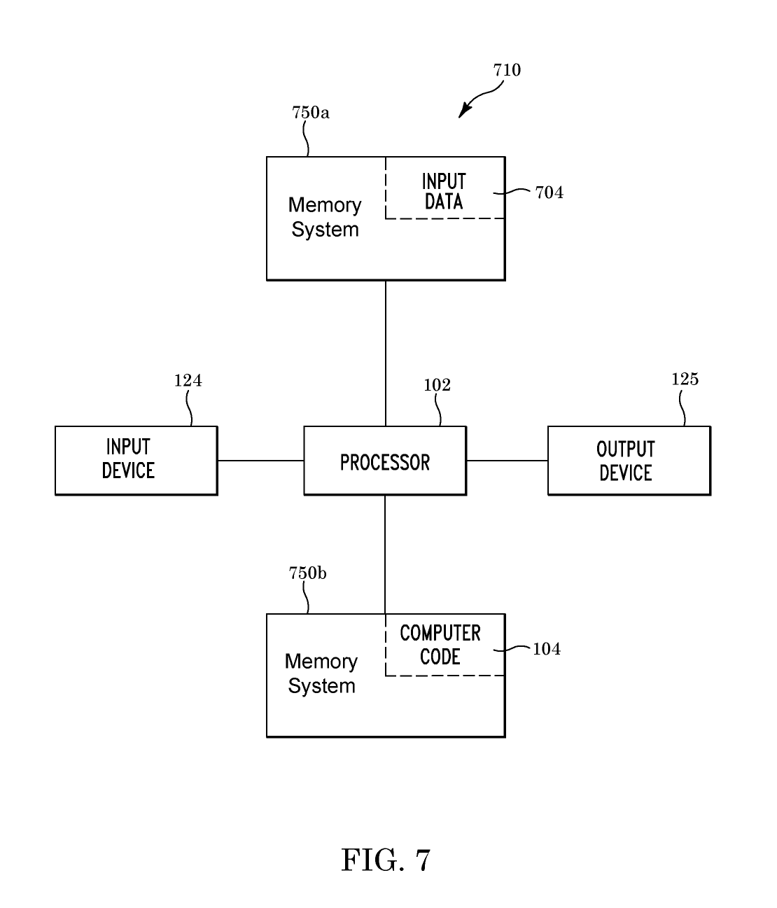

FIG. 1 provides a schematically presented embodiment of a digital platform 100 remotely accessed by a computer based infrastructure 101. The computer based infrastructure 101 may include a computing system 110 comprising a processor 102, an input system 124 and an output system 125 coupled to the processor 102 via an input/output (I/O) interface 118 and a memory system 150 comprising or more memory systems coupled to the processor 102 via bus 120. The memory system 150 may include a single memory system 150 or alternatively a plurality of memory systems 750a, 750b as shown in embodiment 710 of the computing system of FIG. 7.

The input system 124 may be include, inter alia, a keyboard, pointing system such as a mouse, remote, joystick or hepatic feedback system, data collection systems such as biometric scanners, barcode scanners, or any other known input systems which may enable the computer system 110 to receive input data 704 from one or more other computing systems or users transmitting input data 704. The input data 704 may be transmitted to the processor 102 or memory 106 via a communication link 122. Embodiments of the communication link 122 may be, for example wired or wireless links, one or more types of networks (such as internet, wide area network, local area network, virtual private network) and/or any known transmission techniques and protocols, such as TCP/IP for example.

The output system 125 may be, inter alia, a printer, a plotter, a display system (such as a computer screen), touchscreen display, a magnetic tape, a removable hard disk, a floppy disk, or any other output systems known by those skilled in the art. The memory system 150 of the computer system 110 may include one or more memory systems which may be, inter alia, any computer readable storage media such as a hard disk, a floppy disk, a magnetic tape, an optical storage such as a compact disc (CD) or a digital video disc (DVD), random access memory 108, a dynamic random access memory (DRAM), a read-only memory (ROM) 112, etc.

Embodiments of the processor 102 may execute the program code and logic of the digital platform and methods described herein and/or the source or target program 104 of the digital platform, which may be stored in the memory 106. While executing the program code stored in the memory 106, the processor 102 may be able to read and/or write data to and from the memory 106, the remotely accessible content located on the platform's network 126 and/or the I/O interface 118. The bus 120 may provide a communication link between each of the components in the computing system 110.

In some embodiments, the computing system 110 may include a source or target program 104 which may be fully compiled, assembled and pre-loaded with computer executable instructions onto the computing system 110, creating an interface for the computing system 119 to access and interact with the digital platform network 126 of the digital platform 100. In other embodiments, the computing system 110 may include program code which may include executable program code or instructions stored in the memory 106 of the computing system 110. These instructions may be stored in them memory 106 temporarily or permanently in some embodiments.

In some embodiments of the digital platform 100, the processor 102 may execute the source program 104 or program code logic stored in the memory 106 of the memory system 150. In some embodiments, the memory system 150 may include input data. The input data may include any inputs required by the program code, which may be received by one or more input systems. The output system 125 may display output from the program code. Embodiments of the memory system 150 may be used as a computer usable storage medium (or program storage system) having a computer readable program embodied therein and/or having other data stored therein, wherein the computer readable program comprises the computer program code of the digital platform 100. Generally, a computer program product (or, alternatively, an article of manufacture) of the digital platform system 100 may comprise said computer usable storage medium. Thus the present invention discloses a process for supporting, deploying and/or integrating computer infrastructure, integrating, hosting, maintaining, and deploying computer-readable code into the computer system 110, wherein the code 104 in combination with the computer system 110 is capable of implementing a digital platform for selling and performing automobile related service transactions.

A computer program product of the present invention comprises one or more computer readable hardware storage systems having computer readable program code stored therein, said program code containing instructions executable by one or more processors of a computer system to implement the methods of the present invention.

A computer program product of the present invention comprises one or more computer readable hardware storage systems having computer readable program code stored therein, said program code containing instructions executable by one or more processors of a computer system to implement the methods of the present invention.

A computer system of the present invention comprises one or more processors, one or more memories, and one or more computer readable hardware storage systems, said one or more hardware storage systems containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible system that can retain and store instructions for use by an instruction execution system. The computer readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded system such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing systems from a computer readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing system receives computer readable program instructions from the network and forwards the computer readable program instructions for storage in a computer readable storage medium within the respective computing/processing system.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other systems to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other system to cause a series of operational steps to be performed on the computer, other programmable apparatus or other system to produce a computer implemented process, such that the instructions which execute on the computer, other programmable apparatus, or other system implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

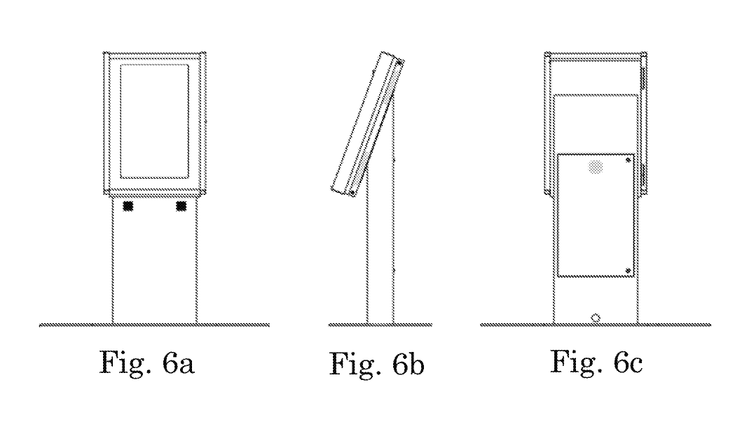

Examples of a computing system 110 may include personal computers, laptops, tablets, smartphones, cellular telephones, smart televisions or other media players and systems. In some embodiments, the computing system 110 may be referred to as a touch point system, wherein the user of the system accesses the information on the digital platform network 126. The exemplary computing system may resemble a hub or kiosk such as the one depicted in FIGS. 6a, 6b and 6c of this application which may have specialized circuitry, firmware or the digital platform program coded in a ROM integrated as part of the memory system 150 in some embodiments. Embodiments of the computing system 110 may act as a workstation or physical system which may send and receive input requests by a user attempting to access, manipulate, display, store and update information provided or stored on the digital platform's network 126. In some embodiments, the computing system, such as the kiosk located at a participating dealership, may retrieve and displays inventory of the participating dealership in real-time as a function of the input data of the user of the computing system.

In some embodiments, the computing system 110 and its surrounding computer infrastructure 101 may be connected to the digital platform's network 126 via a network connection 128. This network connection 128 may be established between the computing system 110 and the digital platform network 126 using any known or established network communication means. Examples of network communication means may include electrical cables such as Ethernet, powerline communications, fiber optic connections and radiowaves such as wifi, Bluetooth or other types of wireless networking transmissions. The established network connection to the platform network 126 may include local area network (LAN) or a wide area network (WAN), or any connection may be made to an external computer (for example, through the Internet using an Internet Service Provider). In some embodiments, the digital platform may operate as a cloud based network providing software applications to the computing systems connected to the platform network 126 from a remote location over the network connection 128.

Embodiments of the digital platform network 126 may send, receive, and store the content and applications accessible by each of the computing systems 110 (for example computer systems 110a, 110b) connected to the network platform 126. Embodiments of the digital platform network 126 may comprise a content management system 130, a customer database 132, and a communication platform 134. The content management system 130 may be a computer application or software program which may store and organize files, and provide access to the data of the digital platform. The content management system 130 may deliver to each connected computing system the program features that may be displayed on an output system 125 of the computing system 110, such as a display system.

Embodiments of the content management system 130 may be responsible for providing each of the features to the computing system 110 which may be observed, and manipulated by a user interacting with the computing system 110. For example, in the exemplary embodiment where the digital platform 100 is directed toward vehicle and automobile sales, the content management system may include automobile-related features such as information, images and files accessed by the computing system related to the vehicle inventories, makes, models, accessories and customization programs of automobiles as well as prices, services, test drive scheduling, maintenance scheduling, payment processing, payment calculators, financial services including bank, OEM and lease offers, credit checks, and trade-in appraisal services which may feature real-time trade equity values. In particular, any of the content that is published and displayed on the computing system's output 125 for the customer to access may be controlled and provided by the content management system 130.

In some embodiments of the digital platform 100, a customer database 132 may be provided as a feature for creating and storing session information of each user and record the personalized details of each user's interaction with the computing system having the digital platform accessible thereon. The customer database 132 may work in tandem with the content management system 130 being accessed by the computing system 110. The customer database 132 may keep track of each of the individual users which may access the computing system 110, including customized customer relationship management (CRM) strategies directed toward obtaining preferences of each individual user, characteristics of the user, user contact information, user input data into the computing system 110 and the input system 124 thereof, including keystrokes and mouse, our touchscreen activities performed by the user while accessing computing system 110. Other information stored by the customer database may include documents relating or connecting the user to the DMV, such as the user's driver license, vehicle registration, insurance information of the user, a soft pull of user credit information which may be stored for the purposes of prequalification of financing. In some embodiments, the digital platform may be able to tie the scanned driver's license of the user to a full credit bureau report which may be stored on the digital platform and accessible to participating dealerships.

In some embodiments, the customer database 132 may identify and track the user's interactions with the digital platform via the computing system 110 by requiring individual users to register with the digital platform program loaded on the computing system 110. Registration with the digital platform 100 may include the steps of providing identifying information and/or setting up a username and password. During the registration process of a new customer, the customer creating the new registration and profile for the customer database may select a sales person to assist the customer and associate the sales activity and customer database related data created during the customer's session with the digital platform.

In some embodiments, the computing system 110 connected to the digital platform 100 may include an input system 124 such as scanning system. The scanning system may further be used to record or scan user identification such as a driver's license or scan the user for identifying characteristics such as biometric data. Biometric data may include facial recognition, iris scanning, or finger-printing the user. Using the scanned driver's license information or biometric data, the computing system 110 may create, build and store data of each user in the customer database 132 and tie the data to the particular user information retrieved by the computing system 110 from the content management system 130, such as the user's name, contact information, driver license number, a scan of the user's driver's license, a sales associate in charge of assisting the user, the credit score of the user, which may be obtained securely without having to enter a social security number (SSN) or date of birth (DOB), pre-qualification and/or pre-approval of financing, ad-sources, marketing material or referral information that brought the user to the participating dealership, geolocation of the user and/or the ad-sources, the zip code of the user and the ad-source or marketing material that brought the user to the participating dealer's location or website.

For example, in some embodiments, a user may have to identify themselves to the computing system 110 they are using to access the digital platform, before accessing the files of the content management system 130. Once a user has identified themselves to the computing system 110, and access has been granted to the user, the customer database 132 may log and/or display the user's personal information, driver license record and browsing habits of the content distributed by the content management system 130. The digital platform 100 may further generate useful and valuable information about each user which may be recalled at a later point in time or accessible to participating dealerships or third party vendors who may find the information useful, such as the user's credit score, real-time trade equity value of user's current automobile, user's origins/geolocation which may be sorted by zip code, ad-sources and referrals that drove user's to a particular geolocation or computing system having access to the digital platform, along with browsing history, past customized vehicle and automotive shopping information, previous and pending maintenance and services requests, and customized payments or lease negotiations which may be based on the user's credit score previously performed by the digital platform and stored by the customer database 132.

The information collected and correlated to a particular user may be useful to participating car dealerships in one or more embodiments utilizing the digital platform 100 for enhancing car shopping and buying experience. For instance, in the exemplary embodiment, the customer database 132 may record and identify for each user, valuable information regarding the user's vehicle preferences, price range, customized options, vehicle comparisons, test drive appointments, trade-in value of a previous vehicle, financial information, credit score or any other information capable of being input into the computing system 110 via the input system 124 or retrieved by the computing system 110 through the manipulation of the content displayed to the user during the user's session with the digital platform 100. The information relating to the user's identity and the input data provided by the user may be forwarded to participating dealerships so they may contact the user regarding a potential sale, or identify general characteristics, trends and preferences of similar users in the same demographic as the user registered with the digital platform 100 as well as identify ad-sources and referrals driving floor traffic to dealerships, customer origins/geolocation and the average ratio of ad spending costs to in-store arrivals at participating dealerships.

In some embodiments of the digital platform, the scanning systems act of scanning a user's driver's license or biometric data may instruct the digital platform to further perform the act of retrieving a credit score of the user. In some embodiments, the credit score may be considered a “soft pull” credit score and may be for the purpose of generating customized financing options or payments finance through pre-qualification as a function of the user's credit score, allowing for participating dealerships to display customized quotes for their inventory for the user. In some embodiments, the digital platform may retrieve the credit score from a credit scoring engine connected to the digital platform. The credit scoring engine may be able to retrieve an overall credit score or may retrieve a full credit bureau of the user and save the information in the user's entry of the customer database 130.

By retrieving and/or storing the credit score of the user through the use of the digital platform and/or the scanning system, the digital platform may pre-qualify users quickly, organize automobile related features, such as inventory by payment amounts and lease payments, provide instant and perform real time trade in valuation, payoff and equity calculations for the user directly through the digital platform. The retrieval of the credit score from the credit scoring engine may be full federal, state and OEM compliant disclosures, present all OEM qualifying programs, rebates and incentives to the user, customize tiers of credit ratings in a manner set up or personalized for each participating dealership, generate and store in the customer database 132 any forms or paperwork that may be necessary to fill out for receiving customized pricing, financing, incentives and OEM qualified pricing.

In some embodiments, the customer database 132 may additionally include analytics software or an analytic database. Embodiments of the analytics software of the customer database 132 may be specifically designed to support business intelligence and analytic applications of the data collected and stored by the customer database. In some embodiments, the analytics software may be part of a data warehouse or data mart. Embodiments of the analytics software of the customer database 132 may operate to identify meaningful patterns in the data stored by the customer database, capture or identify floor traffic patterns at participating dealerships, identify the origins of customers entering participating dealerships including identifying ad sources and referrals driving customers into the participating dealerships allowing participating dealerships to compare and contrast ad-spending versus the dealership traffic received. The analytics software may not only identify meaningful patterns about each individual user and participating dealerships, but may also identify the patterns or more specific demographics of users or dealership and present this information to network administrators or network participants receiving the customer database information.

In some embodiments, the analytics program of the customer database 132 may analyze one or more of each of the entries in the customer database 130 and use the identifying information collected by the customer database 132, including zip code and ad-source information to correlate each user to an ad-source surmising the ad-source that is referring the user to a participating dealership and actually results in bringing the user physically to the dealership location. The digital platform may, in some embodiments, generate a map of each user of the digital platform based on the geolocation and ad-source information and other personal identification information collected by the digital platform. The generated map may be stored, updated, accessed and displayed by the digital platform to participating dealerships.

Feedback from the analytics software may be used in some embodiments to target sales to one or more specific users or a group of users of the digital platform 100. In some embodiments, the data collected and analyzed in the customer database 132 may be used to update or modernize the content delivered by the content management system 130 to further suit the needs of the platform 100 and the user's the platform 100 serves. In the exemplary embodiment, the information generated and analyzed by the customer database analytics software may also be utilized by dealerships to identify specific industry trends and allow them to adapt. Adaptation using the analytics software may include determinations by the analytics software of popular makes and models of vehicles which are viewed more frequently by users, preferred options packages for particular vehicles, successful promotion or ad campaigns. In turn, participating dealerships with access to the customer database 132 and/or analytic software may choose to dynamically adjust their inventories, pricing, promotions, advertising, marketing material accordingly to correspond with the findings and patterns of the analytics software of the digital platform 100.

In some embodiments of the digital platform 100, the digital platform may include a communications platform 134 connected to the network 126. The communications platform 134 may include hardware and software infrastructure which may have capabilities for sending and receiving the content of the digital platform 100, including the content of the content management system 130, the customer database 134, and input data from the users of the computing system 110. For example, in some embodiments, the communication platform 134 may include one or more central servers or secondary servers which may contain middleware. The middleware may send and receive requests between the components of the platform's network 126 and the connected computing system 110. In the exemplary embodiment, such as retail automobile sales, the communication platform 134 may be a closed network of participating dealerships and third party retail locations having specific computing systems 110 with the available program code or source program 104 loaded in the memory of the computing system 110. In other embodiments, the communication platform 134 may be widely available to any computing system 110 loaded with the digital platform program 104, such as a computing system 110 loaded with the appropriate mobile application of the digital platform program 104 which may be publicly available for download by users and loaded in the memory system 150 of the computing system 110.

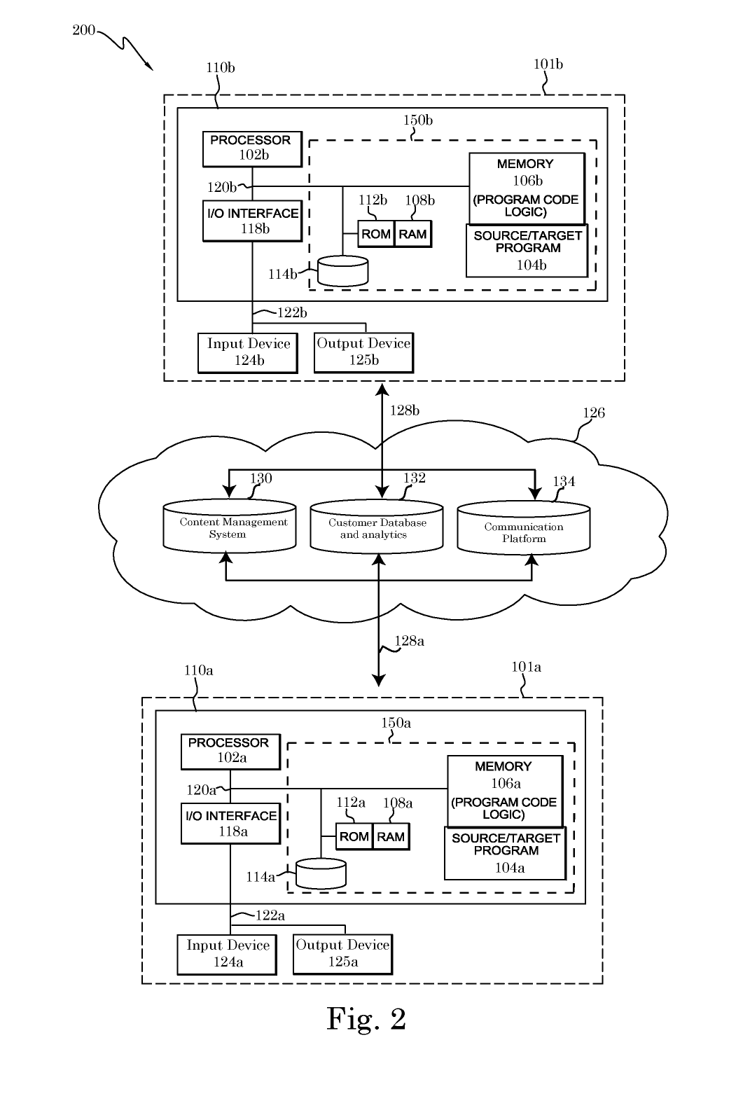

Referring to an alternative embodiment 200 in FIG. 2, some embodiments of the digital platform 200 may be accessed by a plurality of computing systems 110a, 110b connected to the digital platform network 126 via a network connection 128a, 128b established by each computing system 110a, 110b. The computing systems 110a, 110b connected as part of the digital platform 200 may be one or more customers, one or more participating dealerships or a combination thereof. For example, in a digital platform directed toward automobile sales, the individuals accessing the digital platform 200 may dynamically change in real time as users sign on and off, connect or disconnect each respective computing system 110a, 110b that is connected as part of the platform 200. In some instances, each of the one or more users accessing the platform at a given moment may be one or more potential customers looking to eventually purchase a vehicle. In other instances, one or more of the individual computing systems accessing the platform may also be a participating dealership who may pay or subscribe to access the customer database 132, the analytics information or receive potential sales leads from the digital platform 200. The digital platform may therefore be sending and receiving information to and from potential purchases, participating dealerships and third party companies or individuals interested in the data generated by the digital platform 200 and the customers' interactions with the platform 200 on their computing systems 110a, 110b. The example shown in FIG. 2 is not limited to the two computing systems shown in the figure; rather, a plurality of computing systems may connect to the digital platform and may only be limited by the maximum number of simultaneous connections that may be allowed by the hardware and software supporting the platform 200.

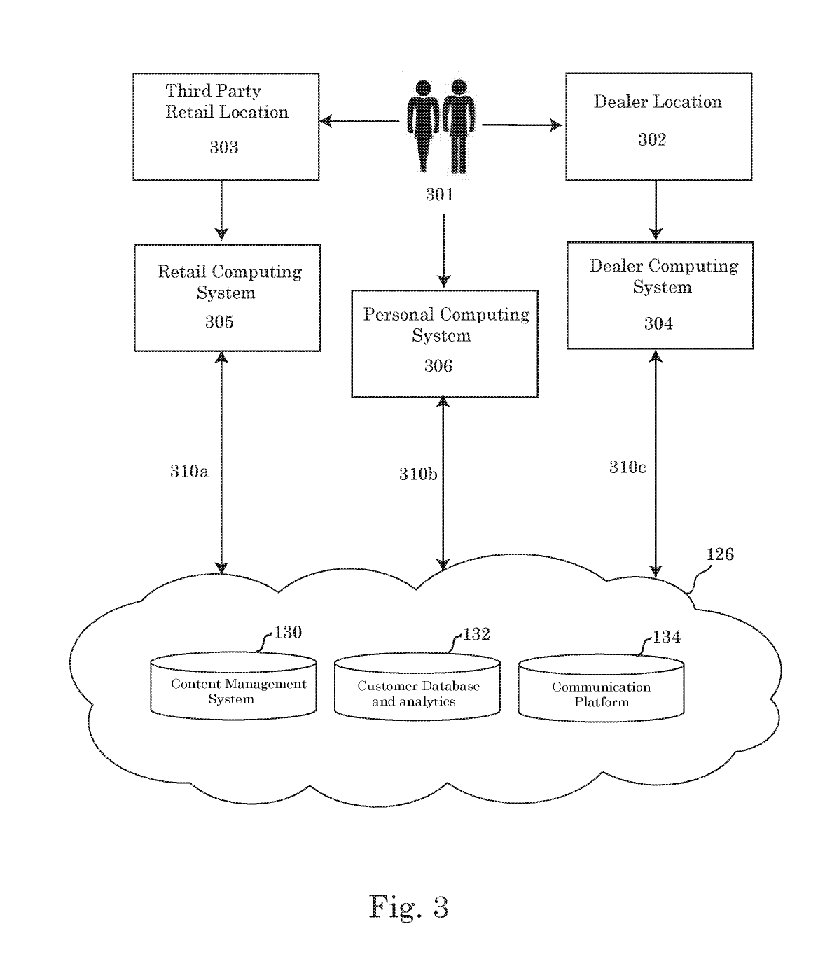

Referring to FIG. 3, users 301 of the digital platform 100, 200 may access the digital platform network 126 from a plethora of different locations and computing systems. Each of the computing systems 110 and platform software 104 loaded into the memory of the computing system 110, may allow access to different platform features depending on the access permissions granted by the administrators of the digital platform 100,200. In the exemplary embodiment, the user 301 may access the content stored by the platform network 126 from a retail computing system 305 installed at a third party retail location 303, a dealer computing system 304 installed at a participating dealer location 302 or a personal computing system 306 owned or operated by the user 301 themselves, having the digital platform program 104 installed thereon. A user may begin using the digital platform at one of the computing systems at a particular location and subsequently change locations and resume or recall a session from a previous location at the second location seamlessly and without loss of data or information that was previously provided to the digital platform, allowing for users in some embodiments to begin researching or negotiating for a vehicle from a personal computing system 306, then move to the dealer location 302 and finish the purchase transaction from the dealership floor using the dealer computing system 304, without having to restart the purchasing steps.

In some embodiments, one or more dealer computing systems 304 provided at the dealer location 302 may be strategically positioned to various sections of the participating dealership. Embodiments of the dealer computing systems 304 may include a physical kiosk located at the participating dealership that connects via a network connection 128 to the network 126 of the digital platform 100, 200. For example, a dealer computing system 304 may be available on the showroom floor to guide customers through the available inventory and purchasing options without the assistance of a salesperson. The dealer computing system 304 may also be placed around or near service lanes to attract customers who may be having their vehicle serviced by the dealership. The placement near a service lane may inform the user 301 about potential savings on purchasing a new car available at the dealership informs the client about other services they may wish to consider while currently at the dealership or provide them with savings on services they may already be receiving. A user may use or manipulate the functions of the dealership computing system 304 as a function of the user's input data to perform any feature offered by digital platform such as the automobile related features described in this application, including retrieving and displaying the inventory of the participating dealership in real-time.

Each of the computing systems 304, 305, 306 installed at their particular locations may establish an independent and distinct network connection 310a, 310b, 310c with the platform network 126. Once the network connection has been established, the communication platform 134 may identify each of the computing systems 304, 305, 306. In some embodiments, the location or type of computing system 304, 305, 306 may result in restricted or limited access to the customer database 132 or content management system 130. For example, a user experience at a retail computing system 305, installed at a third party retail location 303, may have unfettered access to every make and model of automobiles or services offered by participating dealerships who contribute to the content provided by the platform 100, 200. When a user is manipulating the retail computing system 305, for example by browsing or comparing vehicles at the third party retail location 303, the user 301 may perform any number of actions directed toward the automobile-related features by manipulating the retail computing system 305 as a function of the input data provided by the user 301. The input data by the user 301 may include cross-shopping and comparing inventory between different dealerships, and vehicle brands, customizing vehicles available from one or more dealerships, calculation and negotiation of customized payments and financing which may occur automatically in real-time based on the credit score of the user, scheduling test drives for multiple locations, scheduling a test drive for multiple vehicles at a retail location, researching current specials, inquiring about financing options or viewing maintenance services offered by each of the participating dealerships. In some embodiments, the inventory displayed to the customer by the digital platform may be updated in real time and include products and features of actual automobiles associated with a particular VIN number.

In some embodiments, a dealership computing system 304 connected to the network platform 126 from a particular dealership location 302 may have limited or a restricted number of features, which may be otherwise available at a third party retail location 303. For example, a dealership computing system 304 may restrict the content management system 130 from providing every make and model of vehicles when a user is shopping at the specific dealership location 302. The dealership computing system 304 may in some embodiments only allow the user 301 to search and review vehicles, customize vehicles or view content specific to the dealership's inventory, a family of related dealerships or restriction actions to the makes and models of vehicles the dealership or family of dealerships sell. For example, a dealer computing system 304 installed at a participating Honda dealership location may prevent the computing system from receiving information about vehicles made by competitors such as Toyota, Ford, Chevy, Volkswagen, BMW, etc. Moreover, the computing system installed at the Honda dealership may further prevent access to information normally stored in the content management system 130 about other competing Honda dealerships. In some embodiments, the dealership computing system 304 may access inventory, information and services provided the specific dealership (such as the Honda dealership in the example) as well as the manufacturer's website and general information provided about the manufacture's products and services stored by the content management system 130.

In some embodiments, a user 301 who may be a potential customer may access the platform network 126 from their personal computing system 306. The restrictions placed on the viewable content from a personal computing system 306 may vary depending on the settings chosen by the administrators of the digital platform 100, 200. For instance, in some embodiments, the personal computing system owned by the user 301 and loaded with the platform software, may have equivalent access permissions as the retail computing system which may access the entirety of the content management system 130. This may include access to all current inventories, customization of a vehicle with all makes and models of vehicles available, pricing information for each participating dealership as well as their current specials, and available services from each participant. In alternative embodiments, the access to the content management system 130 from the personal computing system 306 may be limited in some embodiments. In some embodiments, platform program installed by the user 301 may be a vehicle manufacturer specific program or a dealer specific program. In that case the accessible features provided by the dealer or manufacturer specific program may be more restrictive, similar to the dealer computing system 304, described above. Likewise, a more general purpose or third party retail version of the platform program loaded into the memory of the personal computing system 306 may be less restrictive or restriction-less, providing broader access to a plurality of dealerships and vehicle suppliers as described by the retail computing system 305 above.

The restrictions to the individual programs of the digital platform may be implemented to encourage users 301 to find their nearest retail location 303 which will provide them full and unlimited access to the content available in some instance. In other instances, the network platform 126 may encourage the user 301 to seek out their local automotive dealer location 302 for additional pricing information, availability of the desired vehicle or to view dealers' current specials, promotions and inventory. This method of access restriction may be implemented purposefully in some embodiments in order to encourage users 301 who are potential clients to enter a retail location 303 or a participating dealership location 302.

Conversely, not only may the user 301 be faced with various content imposed accessibility limitations, depending on the location and type of computing system accessing the content of platform network 126, but specific network partners and subscribers, such as participating dealers subscribed to the digital platform services, may also be limited by their access to specific information generated by the digital platform in some embodiments. For instance, one or more specific automobile dealerships that are participating in the platform may have restricted access to the customer database 132 and analytics information. In some embodiments, a specific dealership may only have access to analytics information or sales leads generated for their dealerships, sales regions, available brands or available services. For example, a participating Ford dealership may receive information specifically for clients who viewed their Ford specific inventory or competing Ford dealership inventory. This information may include make and model information, the age and sex of the registered customer, services viewed, contact information for contacting the potential customer and details of the user's 301 specific interaction and manipulation of various features of the computing system loaded with the digital platform program. In some embodiments, the same Ford dealership located in New York may not have access to customer database information about clients outside their region, such as in California for example. However, the participating dealerships may have access to immediately adjacent regions, or a region within a specific distance from the participating dealership. In other embodiments participating dealerships may be restricted from accessing information about users 301 relating to non-Ford dealerships.

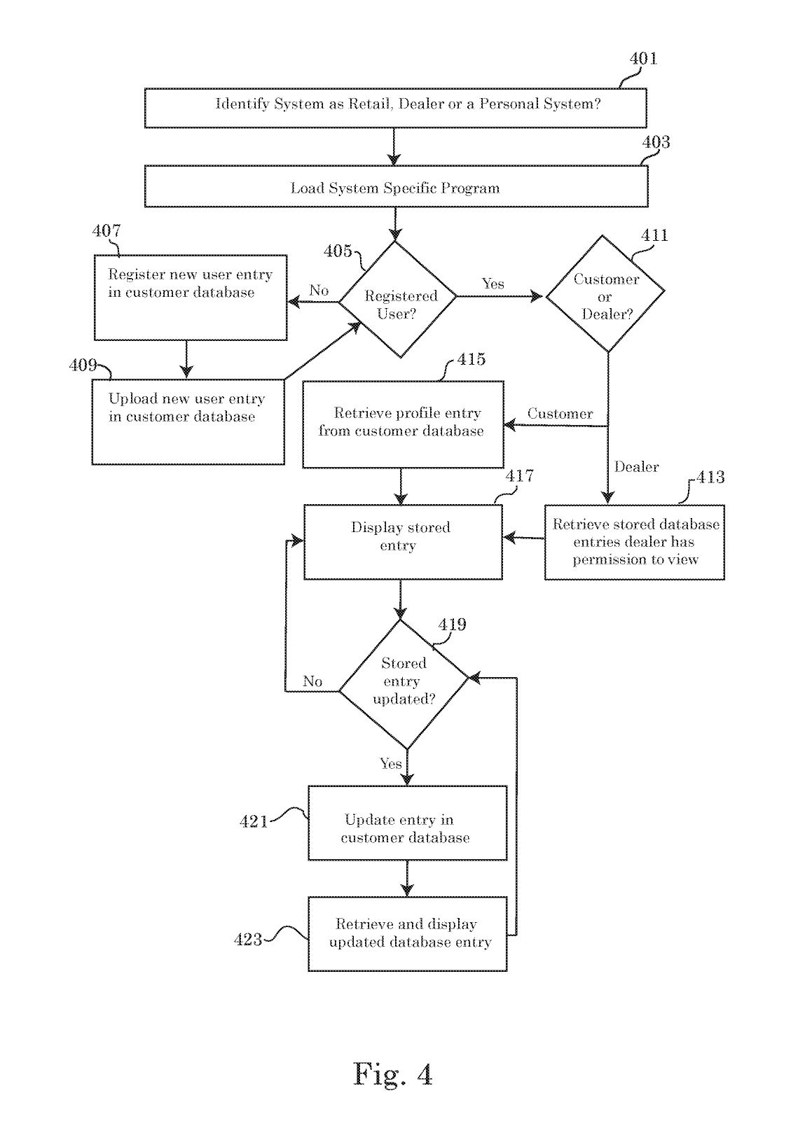

Referring to FIG. 4, the schematic provides an example embodiment of a method for identifying specific program related features of the digital platform, registering users and creating a profile that tracks the user's information and the user's experience with the digital platform. In some embodiments, the platform network 126 may begin by identifying 401 each computing system establishing a connection to the digital platform. In some embodiments, the digital platform may independently assign specific access permissions to each of the connected systems depending on the type and location of the computing system. For example, the digital platform may identify the computing system in step 401 as a retail computing system 305, personal computing system 306 or dealer computing system 304 in some embodiments. The identified computing system's access to content of the platform may be controlled in step 403 by loading a system specific program in the memory of the computing system or the program determining the content accessible may be preloaded in the memory of the computing system before the network connection is established to the platform network 126. However, in some embodiments, the limitations and permission for the various content available within the content management system 130, customer database 132, and the analytics software on the network 126 may be implemented by the software loaded in the memory of the computing system.

Once the computing system has loaded the system specific platform software, allowing access to the network platform in step 403, a user may request access to the content of the network 126. In some embodiments however, the order of the steps described herein may be performed in a different order than shown specifically by the figures. For instance, in some embodiments, the step of loading the system specific program in step 403 may actually occur before the digital platform identifies the system as being a retail, dealer or personal system.

In step 405, the digital platform program 104 loaded on the computing system 110 may request that the user 301 supply their login credentials in a manner that is identifying the user to the digital platform in order to access the digital platform before the user 301 begins accessing the content of the digital platform's network 126 or manipulating the various automotive-related features provided by the digital platform. In some embodiments, access may be granted to users in step 405 to users who have registered identifying information about themselves with the digital platform. The registration of each user may allow the digital platform to more easily and efficiently associate the identifying information accessed by each user and the user's actions performed on the computing system 110 accessing the digital platform to be tied to a specific user and further allow the digital platform to record user specific information in the customer database 132. As part of the logon procedure, a user may be identifying themselves to the computer system 110 that is connecting to the network 126. In some embodiments, the user may be receiving identifying information such as a name, logon/password, a scan of the user's driver's license or biometric data in order to identify the user and access the digital platform.

If a user 301 does not have login credentials and has not registered with the digital platform, the digital platform may register the new user in step 407 with the digital platform. The new user registration step 407 may be performed by having the user register as new user entry in the customer database 132, by providing identifying information of the user in some embodiments and then subsequently in step 409 uploading the new entry to the customer database 132 to the platform network 126. When a previously registered user accesses the digital platform the next time, the computing system accessing the content of the digital platform network 126 may be receiving the identifying information as part of the identifying step, to confirm the identity of the user.

In some embodiments, the identifying information provided may include the user's name, address, telephone number, age, sex, income, currently owned vehicle(s), email address, desired username and password, biometric data such as a fingerprint or iris scan, or a user may scan a copy of the user's state issued driver's license. In some embodiments, the digital platform may access the department of motor vehicle records and download the identifying information about the user from the user's driver license data and use the driver license data to create the user profile stored in customer database 132.

In some embodiments, the customer may furnish additional information during the registration process to the digital platform that may be useful to participating dealerships, including customer identified advertising material and referrals that may have resulted in the use of the digital platform or identifying the participating dealership as a potential point of sale. This additional advertising and referral information may be particular useful to the analytics program of the customer database 132, because it may allow for patterns trends to be identified for useful and profitable uses of advertising, marketing and other methods for increasing floor traffic to participating dealerships.

Alternatively, in some embodiments, users 301, participating dealerships and digital platform administrators may already having login credentials registered with the digital platform. Under these circumstances, a previously credentialed user may provide identifying information that has been saved with the digital platform to grant access to the digital platform. An example of identifying information may include logging in with a user name and password, having the computing system scan the driver's license or scanning a the credentialed user for biometric information that may have been previously stored during the new registration process of steps 407 and 409.

Once a user or participating dealer has been credentialed and successfully logged in to the digital platform, the digital platform program may identify in step 411, whether the credential user accessing the digital platform is a customer or a participating dealership who subscribed to receive information and data about customers accessing the platform network. If the user 301 accessing the digital platform is a customer, in step 415, the digital platform, via the communication platform 134 may retrieve the profile entry information stored about the customer in the customer database 132. Subsequently, once retrieved in step 415, the digital platform may in step 417 display the profile information stored in the customer database on an output device 125 such as a display screen for the customer to view and see.

If, in step 411, it is determined by the digital platform that the user 301 accessing the digital platform is a participating dealer or system administrator, in step 413, the digital platform may retrieve one or more stored database entries and digital platform related data about customers available that the dealer or administrator has permissions to view and/or edit. In step 417, the digital platform may display one or more of the database entries of the customer database retrieved during step 413.

In some embodiments, the information recorded in the database and displayed by the digital platform in step 417 may dynamically change every time a customer or participating dealer initiates or utilizes a feature of the platform by manipulating the features presented on the computing system connected to the digital platform's network 126 as a function of the input data of the user into the computing system 110. The digital platform in step 419 may continuously or periodically retrieve the database entry data and determine whether the information has been updated since the previous retrieval in steps 413 or 415. If the information stored in the one or more displayed database entries has not been updated, the digital platform may continue to display in step 417 the information as retrieved during step 413 and 415.

If however, the entry/entries being displayed in step 417 of the customer database have been updated, for example by the customer's actions, a participating dealership or a system administration, the information displayed regarding the entry may be updated in step 421 to reflect the most up to date information and data. The actions resulting in the update of the customer database may be occurring in real time as the customer is utilizing and manipulating the automotive-related features presented by the computing system 110 of the digital platform. In some instances, a customer may be unaware that each action performed during the operation of the platform as a function of the customer's input data, is being recorded, and updated to the customer database. Subsequently, the updated information may be retrieved from the customer database 132 and redisplayed in step 423. Step 423 may occur without any change in the functionality of the computing system 110 and may occur in the background as the customer or dealer continues to use and manipulate the functions of the digital platform being requested as a function of the customer or dealer's input data into the computing system 110.

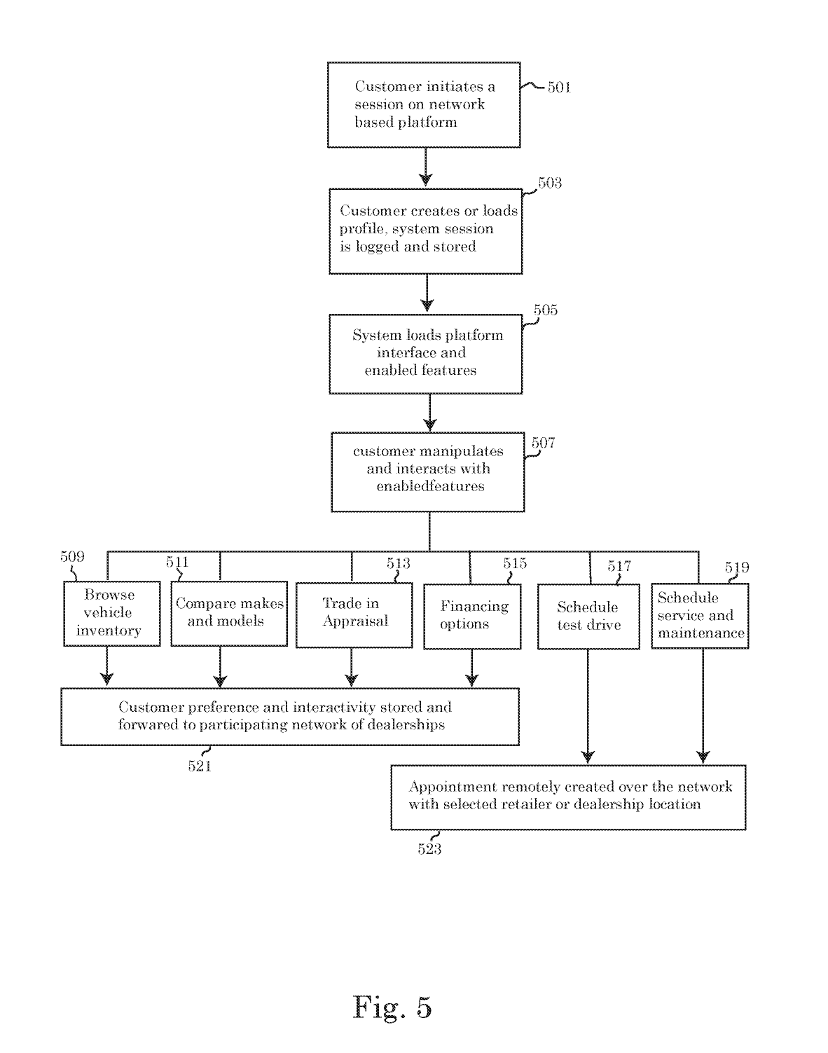

An example of features, operation or input data performed by the customer which may result in updates and modifications to the customer database entry, may include manipulation actions to automotive related features, including those described by the embodiment depicted in FIG. 5. As shown, a customer may initiate a session in step 501, on the digital platform network 126 which may include the step of creating or logging into a profile or entry into the customer database as described in FIG. 4. The information recorded during the session may be tied to the database entry. The session loaded or initiated by the customer in step 501 may be logged or stored locally on the computing system 110 in or more memory system 150 devices in step 505 or alternatively, the actions performed by the customer during the session of the digital platform may uploaded and updated to the customer database 132 stored on the network 126 in a manner consistent with steps 419, 421 and 423. The storage and recordation of the session created in step 503 may occur at discrete intervals of time or in real time as the customer is performing actions by manipulating one or more automotive related features of the content management system 130 presented by the computing system 110.

As previously described above, a computing system 110 connected to the digital platform may in step 505 load the platform's interface, which may be displayed on an output device 125 of the computing system, such as a LCD display or touch screen display. The interface may be provided in step 507 to the computing system 101 and may include the display of numerous enabled automotive related features that the computing system is allowed to access during the current session. The customer may proceed to manipulate and interact with features and objects presented by the computing system on the interface displayed, wherein the customer's interaction in step 507 of the enabled features loaded in step 505 may be recorded into the customer's entry in the customer database system 132.

Examples of automotive-related features which may be enabled for manipulation by the customer may include the ability to browse available vehicle inventories 509 which may be available at participating dealerships or manufactures, comparing and contrasting different makes and models of vehicles 511 (both across brands or within a common brand), customizing vehicles for purchase, appraisals of trade-ins 513, financing options 515 for the inventory the user has browsed or selected, scheduling a test drive 517 for a particular make or model of a vehicle, and scheduling service or maintenance 519 for a vehicle the customer may have already purchased previously. Certain features such as the user's browsing habits of different vehicles, their trade in appraisal and the financing inquiries, may be saved to the customer database and forwarded in step 521 to corresponding dealerships that are participants or subscribers of the digital platform network that may be capable of fulfilling the user's preferences and needs.

In some embodiments of the digital platform, session information may not only include customer information stored by the customer database 132, but the session information may further include relating to employees and staff members of the participating dealerships. Similar to customers, participating dealerships may generate profiles and database entries of their employees and staff including sales activity, whether employee is meeting sales targets, customer relations, feedback and satisfaction with employee.

In some embodiments, scheduling features such as scheduling of test drives 517 and scheduling of maintenance services 519 may be logged in the customer database in addition to interacting with a dealership's scheduling service or application in real time or near real time. As the customer using the platform selects the appropriate time, make and model of the vehicle they wish to test drive or have serviced, the requisite time slot may be accessed and updated on the dealership or retailer computing system or calendar services. For example, a user scheduling a series of test drives may select numerous vehicles starting at the desired appointment time and registering for multiple times thereafter to test drive an additional car. The test drive scheduling may be made at a selected location. For example, a user may schedule test drives at a single retail location which may keep numerous makes and models from different car companies on site so a user may test drive every vehicle at a single location. Conversely, a user may make appointments at one or more dealerships directly to test drive the inventory they have on their lot. Simultaneously or near simultaneously, the appointment application of the dealership or retail location may be accessible through the network platform 126 and may be updated to reflect the newly scheduled test drive appointments.

Embodiments of the digital platform described above may be utilized for varying purposes to bridge the gap between online and physical shopping. In the exemplary embodiments described throughout the application, the described digital platform and methods of use may be implemented to assist both potential customers and participating dealerships to offer a unique, hassle-free car purchasing/sales experience desired by the customer, while simultaneously generating important sales and analytical data and customer data useful to the participating dealerships.

Embodiments of the digital platform described above may be used for implementing methods for purchasing and selling an automobile. The methods for selling (or purchasing) an automobile may comprise the steps of providing one or more computing systems 110, wherein each computing system may be connecting to the digital platform network 126 via a network connection 128. Each of the one or more computing systems may be connecting to the digital platform's network 126 from one or more different locations, wherein each of the locations may have different levels of permission to access the platform network in some embodiments. The access to the digital platform network 126 may be controlled by loading the digital platform network program into the memory 106 of the computing system 110. In some embodiments, the step of loading the digital platform software program may be performed by downloading the software from the network platform's communication platform 134 or content management system 130 into a network connected computing system 110.

The steps of the method for selling or purchasing an automobile may further include registering and identifying a user 301 connecting to the digital platform by creating and accessing an entry in the customer database 132 which may be stored on the platform network 126. The step of creating or accessing an entry in the customer database may act as a means for recording and tracking a user's activity and interactions via the computing system 110 connected to the digital platform network 126. In some embodiments, the step of recording and tracking may be initiated by a user operating the computing system and manipulating or accessing automobile related features displayed by the computing system, received from the content management system 130 and manipulating the features as a function of input data provided by the user of the computing system 110 connected to the digital platform's network 126.

Embodiments of automobile-related features that may be manipulated by a user as a function of the user's input data, and thus tracked and recorded by the digital platform's customer database 132, may include browsing vehicles available in the inventory of participating dealerships, customizing vehicles of one or more makes and models, comparing models available in the inventory or custom made, evaluating trade-in value of their currently owned vehicle, promotional or educational material such as videos or images, providing feedback and survey responses, viewing rebates and promotional pricing, applying for loaner vehicles, requesting brochure or further marketing information, reviewing or selecting financing options, including loan information, insurance information, and leasing information, scheduling a test drive at a retail location or a participating dealership, scheduling maintenance or other services available at a participating dealership or retail location, viewing service specials and/or purchasing manufacturer or third party add-ons such as interior mats, roof racks, tow packages, navigation systems, audio systems, tinting, after-market sun roofs, running boards, intakes, batteries, turbochargers, intercoolers, mufflers, exhaust systems or any other add-on known by those skilled in the art.

The method for selling or purchasing an automobile may further include updating and storing in the customer database 132, session information that is transmitted in or near real time to the customer database 132 as the users manipulate or accesses each of the available provided to the computing system 110 by the content management system 130, including any and all automobile-related feature. In other embodiments of the methods for buying and selling automobiles, the computing system may be saving, compiling or aggregating the session information about the user's interaction with the computing system 110 connected to the digital platform network 126 by storing the session information in its memory 150 or cache, while subsequently transmitting the information back to the customer database 132 at a preprogrammed set of time intervals in order to prevent loss of data if the computing system 110 loses power or connection to the digital platform network 126. In alternative embodiments, the method may include storing temporarily the changes to the customer database entries on the memory system 150 of the computing system and subsequently transmitting each of the changes to the customer database entry at the conclusion of the user's session or by the user manually saving their session during the use of the computing system 110.

In some embodiments of the method for selling or purchasing an automobile, the digital platform may proceed by identifying and analyzing the stored customer database entry information, determining from information stored about participating dealerships, a participating dealership which may offer the products or services most reasonably suited to the users preferences. In some embodiments, the digital platform may proceed by transmitting from the digital platform network 126 via the communications platform 134 to a participating dealership computing system 304, the customer database entries of users being identified by the network platform as sales leads for the participating dealership. The participating dealership receiving the customer database information may proceed by storing the customer database information on the dealership computing system in some embodiments, while in other embodiments, the a participating dealership may access the network platform from a network connected computing system, and thus retrieving the customer database entry information allocated by the network platform to the participating dealership for viewing remotely by streaming the data on demand. Embodiments of the session data tracked, recorded and stored by the digital platform in the customer database 132 may be stored and transmitted XML and/or ADF format in some embodiments. The transmitting and retrieving of information by the participating dealership may useful for generating a sales lead, contacting the user about a potential purchase or offering to sell to the user a vehicle that matches their desired preferences based on the recorded session data of the customer database entry.

In alternative embodiments, a user may not rely on solely on the digital platform for transmitting customer database entry data to one or more participating dealerships. Instead, a user operating the computing system 110 may manually be selecting a participating dealership and requesting that the dealership contacts the customer regarding the sale of a vehicle by transmitting their recorded session information and customer database entry directly to the participating dealership of their choosing.

Data collected during closed testing and pilot programs have suggested that utilizing the described digital platform for generating the sales of automobiles has improved the efficiency and automobile buying and selling experience of both the customer and dealerships, resulting in a highly elevated rates of sales lead generation, reinforcing consumer purchasing and impacting the customer's decision making process. During the implementation of the described digital platform at a retail center in the Cherry Hill Mall in the state of New Jersey, statistics were gathered using the digital platform. Statistical data collected indicated that 97% of consumers using the digital platform would recommend it to others looking to purchase a vehicle. The statistics demonstrated that 84% of the customers who logged in to the digital platform were converted into a sales lead for a participating dealership. Moreover, of those sales leads generated, 42% of the consumers who generated a sales lead, had narrowed down the vehicle they considered purchasing and planned to purchase the vehicle within 3-6 months, while 31% of the customers converted into a sales lead, noted that they had made their final selection on a vehicle using the digital platform and intended to purchase the vehicle in the near or immediate future. Moreover, the gathered statistical data from the pilot program, indicated that 39% of consumers participating in the digital platform pilot, stated that they had test drove a vehicle that they did not originally consider prior to utilizing the digital platform.

Additional statistics have been gathered from dealerships currently participating in the testing phase of the current digital platform and retail centers. From the information gathered by these locations, it has been determined that embodiments of the digital platform described above have further improved not only sales engagement with clients on the showroom floor but have further improved sales and engagement with clients at the service lane of the dealership and has also improved the finance & insurance (F&I) sector of the dealership. For example, participating dealerships have reported that the use of the digital platform described above has resulted in significant results in the F&I department, including at least a 23% increase in product penetration, 20-25% reduction in their transactional time due to the computing system's management of necessary paperwork and customer interview and an overall increase in the per vehicle retail (PVR) which accounts for additional add on and extras bundled with the vehicle sale. The use of the digital platform has further increased customer attitudes toward the F&I process. In particular, surveys conducted using the digital platform experienced a greater number of positive results regarding F&I over traditional F&I procedures. The Initial surveys from our pilot demonstrated a 1.5% uplift in the CEI/CFI score of participating dealerships. This 1.5% increase may be very valuable in terms of dealership ratings. Our pilot dealership, who received the 1.5% increase, resulted in a boost in CEI/CFI score from 94.5% to approximately 96%. Subsequently, the dealership jumped from being the 8^{th} highest in consumer satisfaction for the appropriate region to the top rated dealership in customer satisfaction in the region.

Furthermore, the service lanes at the participating dealerships equipped with a computing system connected to the digital platform's network have experienced at least 50% engagement by customers, more than a 25% increase in trade-in appraisals and a 7-10% conversion rate on service specials available to the customer. Meanwhile, the digital platform enabled computing systems placed on the showroom floor of participating dealerships experienced more than a 90% compliance rate for customer registrations of their license, phone number, email address, including some dealerships recording up to 100% compliance rate. Participating dealerships further identified that the use of digital platform reduced the total sales time from registration to test by more than 30% as opposed to conventional sales techniques provided by a salesmen on the showroom floor engaging customers.

Since the closed pilot programs, the digital platform has been introduced to a plurality of dealerships resulting in the generation of additional statistics indicating the digital platform improves the car purchasing experience, and improves the overall efficiency as well as profitability of participating dealerships. When the digital platform is accessed remotely via the internet using a personal computing system it has been found that the digital platform increases internet based sales leads for participating dealerships by approximately 40%, improves sales lead engagement by 75%, increases the rate of appointments showing up to a dealership by 80% after starting the initial engagement with the participating dealership via the digital platform. It was further found that customers accessing the digital platform remotely via the internet or other network system, using a personal computing system, further resulted an increase in closing ratios by approximately 20%, and increase in front-end profit by 25% and an increase in back-end profit by 33%.

Moreover, statistic gathered by the digital platform when placed in a dealership location and used by customers entering the dealership location, the digital platform increased PVR by approximately $220, increased product penetration by approximately 23%, improved dealership customer satisfaction index (CSI) by approximately 1.5% and the digital platform was able to capture approximately 95% of the floor traffic of customers entering into the participating dealership. In some instances of high usage dealerships, up to 98% of floor traffic information about customers was captured and stored by the digital platform. Furthermore, participating dealerships utilizing the digital platform systems inside their dealerships identified a 39% spike in CRM data captured which included full scans of driver's licenses, telephone numbers and email addresses. Customers using the digital platform at the dealerships purposes were able to reduce the meet and greet for a test drive by twenty-two minutes, down to on average only five minutes and further reduced the entire sales process at the dealership by approximately two hours.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the above described invention.

What is claimed is:

1. A method for selling an automobile comprising the steps of:
connecting, by a computer processor, a computing system to a digital platform via a network connection;
identifying, by the computer processor, a user operating the computing system;
manipulating, by the computer processor, as a function of input data by the user, an automobile-related feature displayed by the computing system;
recording, by the computer processor, the manipulation of the automobile-related feature to an entry in a database describing the manipulating step and the user of the computing system;
storing, by the computer processor, the entry of the database on the digital platform; and
transmitting, by the computer processor, the entry in the database to a participating dealership having access to the database of the digital platform.

2. The method of claim 1, wherein the computing system connecting to the digital platform is a kiosk located at the participating dealership, wherein the kiosk retrieves and displays inventory of the participating dealership in real-time as a function of the input data.

3. The method of claim 1, wherein the step of identifying the user includes receiving biometric data from the user.

4. The method of claim 2, wherein the kiosk includes a scanning system and the step of identifying the user includes scanning, by the computer processor, via the scanning system, a driver's license of the user.

5. The method of claim 4, wherein the step of scanning, retrieves a credit score of the user operating the computing system, generating, by the computer processor, customized financing options for the inventory of the participating dealership as a function of the credit score.

6. The method of claim 1, wherein the digital platform further comprises an analytics program, analyzing each entry into the database, identifying one or more trends and reporting the one or more trends to the participating dealership.

7. The method of claim 6, wherein the analytics program analyzes each entry of the database, generating, by the computer processor, a map of each user of the digital platform based on a zip code and correlating each user to an ad-source referring each user to a participating dealership.

8. The method of claim 2, wherein the automobile-related feature of the manipulating step is selected from the group consisting of comparing and contrasting different makes and models of vehicles, trade-in appraisal, browsing available inventory, customizing a vehicle for purchase and reviewing financing options, available at the participating dealership.

9. A computer program product, comprising:
a computer readable hardware storage system having computer readable program code stored therein, said program code containing instructions executable by a computer processor to implement a method for selling an automobile comprising the steps of:
connecting, by a computer processor of a computing system, the computing system to a digital platform via a network connection;
identifying, by the computer processor, a user operating the computing system;
manipulating, by the computer processor, as a function of input data by the user, an automobile-related feature displayed on the computing system;
recording, by the computer processor, the manipulation of automobile-related feature to an entry in a database describing the manipulating step and the user of the computing system;
storing, by the computer processor, the entry of the database on the digital platform; and
transmitting, by the computer processor, the entry in the database to a participating dealership having access to the database of the digital platform.

10. The computer program product of claim 9, wherein the computing system connecting to the digital platform is a kiosk located at the participating dealership, wherein the kiosk retrieves and displays an inventory of the participating dealership in real-time as a function of the input data.

11. The computer program product of claim 9, wherein the step of identifying the user includes receiving biometric data from the user.

12. The computer program product of claim 10, wherein the kiosk includes a scanning system and the step of identifying the user includes scanning, by the computer processor, via the scanning system, a driver's license of the user.

13. The computer program product of claim 10, further comprising the step of:
analyzing, by the computer processor, each entry of the database to further identify a trend between geolocation of the user and an ad-source;
generating, by the computer processor, a map of each user of the digital platform based on the geolocation and ad-source; and
displaying, by the computer processor, the map to the participating dealership.

14. The program product of claim 12, wherein the step of scanning, retrieves a credit score of the user operating the computing system, generating, by the computer processor, customized financing options for the inventory of the participating dealership as a function of the credit score.

15. A computer system comprising
a computer processor;
a memory system coupled to the computer processor;
a computer readable storage system coupled to the processor, wherein the computer readable storage system contains program code executable by the computer processor via the memory system to implement a method for selling an automobile comprising the steps of:
connecting, by the computer processor, the computer system to a digital platform via a network connection;
identifying, by the computer processor, a user operating the computing system;
manipulating, by the computer processor, as a function of input data by the user, an automobile-related feature displayed on the computing system;
recording, by the computer processor, the manipulation of automobile-related feature to an entry in a database describing the manipulating step and the user of the computing system;
storing, by the computer processor, the entry of the database on the digital platform; and
transmitting, by the computer processor, the entry in the database to a participating dealership having access to the database of the digital platform.

16. The computer system of claim 15, wherein the computing system connecting to the digital platform is a kiosk located at the participating dealership, wherein the kiosk retrieves and displays inventory of the participating dealership in real-time as a function of the input data.

17. The computer system of claim 15, wherein the step of identifying the user includes receiving biometric data from the user.

18. The computer system of claim 16, wherein the kiosk includes a scanning system and the step of identifying the user includes scanning, by the computer processor, via the scanning system, a driver's license of the user.

19. The computer system of claim 16, further comprising the step of:
analyzing, by the computer processor, each entry of the database to further identify a trend between geolocation of the user and an ad-source;
generating, by the computer processor, a map of each user of the digital platform based on the geolocation and ad-source; and
displaying, by the computer processor, the map to the participating dealership.

20. The computer system of claim 18, wherein the step of scanning, retrieves a credit score of the user operating the computing system, generating, by the computer processor, customized financing options for the inventory of the participating dealership as a function of the credit score.
